(19) United States
(12) Patent Application Publication
(10) Pub. No.: US 2006/0256916 A1
(43) Pub. Date: Nov. 16, 2006

(54) Combined ultra-fast x-ray and optical system for thin film measurements

(75) Inventors: Michael Kotelyanskii, Chatham, NJ (US); Andrey P. Vertikov, Lake Hiawatha, NJ (US); Christopher J. Morath, Basking Ridge, NJ (US)

Correspondence Address: HARRINGTON & SMITH, LLP, 4 RESEARCH DRIVE, SHELTON, CT, 06484-6212, US

(73) Assignee: Rudolph Technologies, Inc.

(21) Appl. No.: 11/129,282

(22) Filed: May 13, 2005

(51) Int. Cl. G01N 23/20

(52) U.S. Cl. 378/71

(57) ABSTRACT

A system comprising a means for generating an optical pump beam pulse and for directing the optical pump beam pulse to a first area of a surface of a sample having a plurality of film layers to generate an acoustic signal, a means for generating an x-ray probe pulse and for directing the x-ray probe pulse to a second area of the surface, a means for detecting an intensity of a diffracted x-ray probe pulse the intensity varying in response to the acoustic signal to form a probe pulse response signal, and a means for calculating an expected transient response to a theoretical acoustic signal propagated through a model of the sample and fitting the probe pulse response to the transient response to derive at least one characteristic of the sample.

### FIELD OF THE INVENTION

This invention relates generally to a system for measuring the properties of thin films and, more specifically, to a system which optically induces stress pulses in a film and which measures, via the diffraction and reflectance of x-rays, the propagation of the stress pulses in order to derive a characteristic of the films.

### BACKGROUND OF THE INVENTION

The present generation of semiconductor processes requires the ability to measure thinner films with complex composition and quite often not just on the blanket films, but also on periodic 2D structures. Thickness of the barrier and adhesion layers in the 65 nm design rule processes can be as thin as 10 Angstrom. Uniformity in thickness and composition of these films is critical to the performance of the integrated semiconductor circuits. Reliable and high throughput metrology is critical to deliver high yields of such processes in the high-volume manufacturing.

X-ray measurement techniques such as X-ray reflection (XRR) and X-ray diffraction (XRD) suffer from low photon counts resulting in slow throughput. Examples of these techniques are disclosed in U.S. Pat. No. 6,818,459 B2 to Wack et al. issued Nov. 16, 2004. Also XRR measurements require small incident grazing angles resulting in larger measurement spots. XRD measurements do not provide direct non-calibrated information about layer thickness. A challenge also lies in the fact that several of such films have to be measured simultaneously with the much thicker (1000-3000 Angstrom) metal (usually Cu) films. This makes X-ray reflectivity measurements even more challenging, as their penetration depth is limited by the few hundred angstroms of Cu, and the dynamic range of their detection system must be very high (6-7 decimal orders in intensity, and 2-3 decimal orders in angle of incidence).

The X-ray fluorescence (XRF) technique suffers from low photon counts and lacks the ability to distinguish between similar layers in a multi-layer stack. Current implementations of the opto-acoustic metrology based systems can be used for such measurements, but the response signal is often quite complicated and relies on the accurate knowledge of the mechanical and optical properties of the film layers, which are not always reliable. In addition, the acoustic contrast between the thin layers comprising the barrier may be very weak, making it difficult to resolve these thin layers with acousto-optical methods. Examples of opto-acoustic systems are disclosed in U.S. Pat. No. 5,959,735 to Maris et al. issued Sep. 28, 1999 which is incorporated herein by reference.

A non-destructive, non-contact, small spot, high throughput and high accuracy method is desirable for accurate measurement and control of the thickness and composition of the metal and dielectric films used in the semiconductor industry.

### SUMMARY OF THE INVENTION

In accordance with an embodiment of the present invention, a system comprises a means for generating an optical pump beam pulse and for directing the optical pump beam pulse to a first area of a surface of a sample having a plurality of film layers to generate an acoustic signal, a means for generating an x-ray probe pulse and for directing the x-ray probe pulse to a second area of the surface, a means for detecting an intensity of a diffracted x-ray probe pulse the intensity varying in response to the acoustic signal to form a probe pulse response signal, and a means for calculating an expected transient response to a theoretical acoustic signal propagated through a model of the sample and fitting the probe pulse response to the transient response to derive at least one characteristic of the sample.

In accordance with another embodiment of the present invention, a method for measuring at least one characteristic of a film layer comprises the steps of generating an optical pump beam pulse and directing the optical pump beam pulse to a first area of a surface of a sample having a plurality of film layers to generate an acoustic signal, generating a plurality of x-ray probe pulses and directing the plurality of x-ray probe pulses to a second area of the surface, detecting an intensity of each of a plurality of diffracted x-ray probe pulses the intensities varying in response to the acoustic signal to form a probe pulse response signal, and associating the probe pulse response signal with at least one characteristic of the sample.

In accordance with another embodiment of the present invention, a method for measuring at least one characteristic of a film layer comprises the steps of generating an optical pump beam pulse and directing the optical pump pulse to a first area of a surface of a sample having a plurality of film layers, generating a plurality of x-ray probe pulses and directing the plurality of x-ray probe pulses to intersect a second area of the surface at an angle approximately equal to an incident grazing angle, detecting a plurality of reflected x-ray probe pulses to form a probe pulse response signal, and associating the probe pulse response signal with at least one characteristic of the sample.

In accordance with another embodiment of the present invention, a signal bearing medium tangibly embodying a program of machine-readable instructions executable by a digital processing apparatus to perform operations to measure a thickness of a film layer, the operations comprises receiving an input comprising a time varying signal formed of an intensity of a diffracted or reflected x-ray pulse the intensity varying in response to an acoustic signal propagated through the sample, modeling the sample using at least one model parameter, calculating an expected transient response to a theoretical acoustic signal propagated through the modeled sample, fitting the time varying signal to the transient response, and measuring at least one of the at least one model parameters to obtain a characteristic of the sample.

### BRIEF DESCRIPTION OF THE DRAWINGS

FIG. 1 is a diagram of the combined x-ray and optical system of the present invention.

FIG. 2 is a diagram of the Bragg diffraction condition as it applies to a film layer under investigation by the system of the present invention.

FIG. 3 is a block diagram of the methodology of the present invention.

FIG. 4 is a diagram of an embodiment of the combined x-ray and optical system of the present invention utilizing multiple detectors.

FIG. 5 is a diagram of an embodiment of the combined x-ray and optical system of the present invention showing the grazing incidence angle theta.

FIG. 6 is a flow chart of an embodiment of the sample modeling of the present invention.

### DETAILED DESCRIPTION OF THE INVENTION

An embodiment of the present invention provides a system for utilizing pulses of optical radiation and pulses of x-ray radiation to measure at least one characteristic, including, but not limited to, the thickness of thin film layers. Such layers typically range in thickness from a few angstroms to a few microns. As will be described more fully below, the optical radiation pulses in the form of ultra-short laser pulses are configured and delivered to a sample film in a manner sufficient to generate an acoustic signal within the sample film layers. X-ray radiation pulses are subsequently emitted at the sample and diffracted off of the sample film layers for reception by at least one detector capable of measuring an intensity of the diffracted x-ray pulse. The x-ray pulse generating device and receiver are positioned according to the crystal lattice structure of the layer of the sample to be examined. Such positions are chosen to maximize, or nearly maximize, the change in the received x-ray pulse in response to propagation of the acoustic signal through the sample layer. The received x-ray pulse signals are then analyzed to derive information concerning at least one characteristic, such as the composition of the layer or layers comprising the sample film.

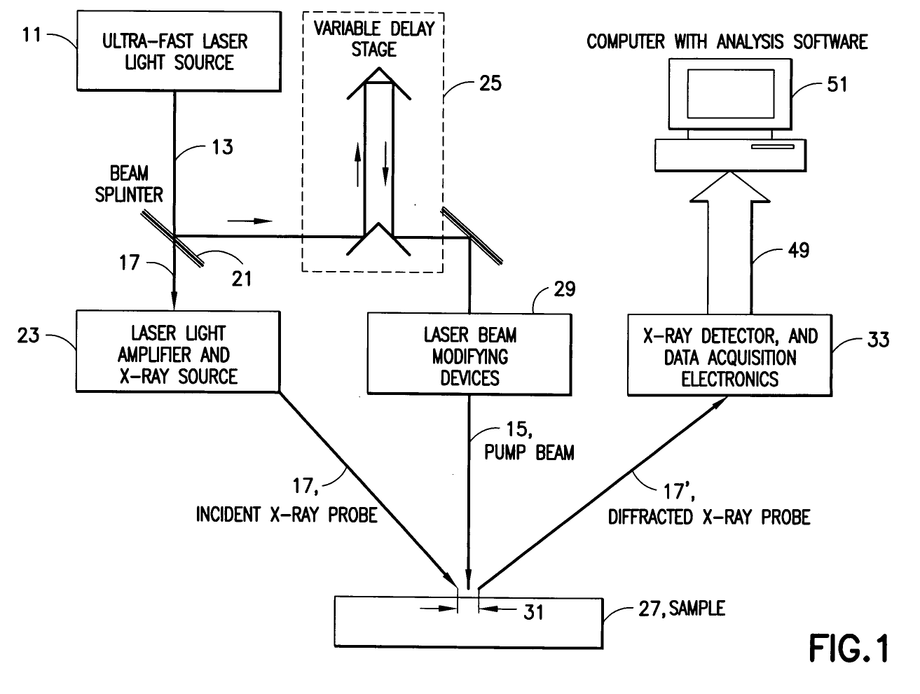

With reference to FIG. 1, there is illustrated a preferred embodiment of the film measurement system of the present invention. Light source 11 is preferably a source of laser light capable of producing pulses of laser light. Light pulse 13 is emitted by light source 11 and preferably forms the predicate for probe pulse 17 and pump beam pulse 15. Use of a beam splitter 21 allows for the formation of both the probe pulse 17 and pump beam pulse 15 from a single light source 11. However, two or more separate and distinct light sources 11 may be utilized to produce the probe pulse 17 and pump beam pulse 15.

The portion of light pulse 13 used to form probe pulse 17 enters a probe pulse modifying device 23. Probe pulse modifying device 23 receives probe pulse 17 in the form of optical radiation and emits a probe pulse 17 comprised of x-ray radiation. Probe pulse modifying device 23 may additionally amplify or otherwise alter the characteristics of the incoming probe pulse 17 prior to emitting and directing probe pulse 17. Examples of such devices consisting of commercially available subsystems are disclosed in scientific literature (e.g., Yang Jian et al “Generation of ultra-short hard-x-ray pulses with tabletop laser systems at a 2-kHz repetition rate” Vol. 20, No. 1 pp-229-237, J. Opt. Soc-. Am. B)

Pump beam pulse 15, preferably formed from light pulse 13, is directed at a surface of a sample 27. It is necessary to be able to control the difference in time between the arrival of pump beam pulse 15 at the sample 27 and the arrival of probe pulse 17.

In the event that pump beam pulse 15 and probe pulse 17 are formed from light pulses 13 each originating from a different light source 11, one may achieve such a difference through control of the times when the pulses 15, 17 are emitted. When, as is illustrated, the pump beam pulse 15 and probe pulse 17 are derived from the same light pulse 13, a variable delay stage 25 may be employed to vary the time at which pump beam 15 is emitted at sample 27. Variable delay stage 25 may be any device capable of receiving an input pulse of light and providing a delay prior to emitting an output pulse of light corresponding to the input pulse. As illustrated, variable delay stage 25 may operate to optically increase or decrease the transit distance of pump beam 15 so as to alter the time at which pump beam 15 exits variable delay stage 25. The delay stage 25 is disclosed in more detail in U.S. Pat. No. 5,959,735 to Maris et al. issued Sep. 28, 1999 which is incorporated herein by reference.

Prior to impacting sample 27, pump beam pulse 15 may pass through beam modifying device 29. Beam modifying device 29 serves to configure pump beam pulse 15. Specifically, beam modifying device 29 can alter the intensity, wavelength, and cross-sectional energy distribution, and direction of the pump beam pulse 15. The examples of intensity and wavelength modifying devices are disclosed in U.S. Pat. No. 5,959,735 to Maris et al. issued Sep. 28, 1999 and cross-section and direction modifying devises in U.S. Pat. No. 6,504,618 to Morath et al.

Probe pulse 17 impacts sample 27 and is diffracted as diffracted probe pulse 17′. Diffracted probe pulse 17′ is detected by x-ray detector 33. X-ray detector 33 is positioned near the direction where the Bragg diffraction condition is satisfied for one or more layers of the sample 27 and operates to detect an intensity of diffracted probe pulse 17′.

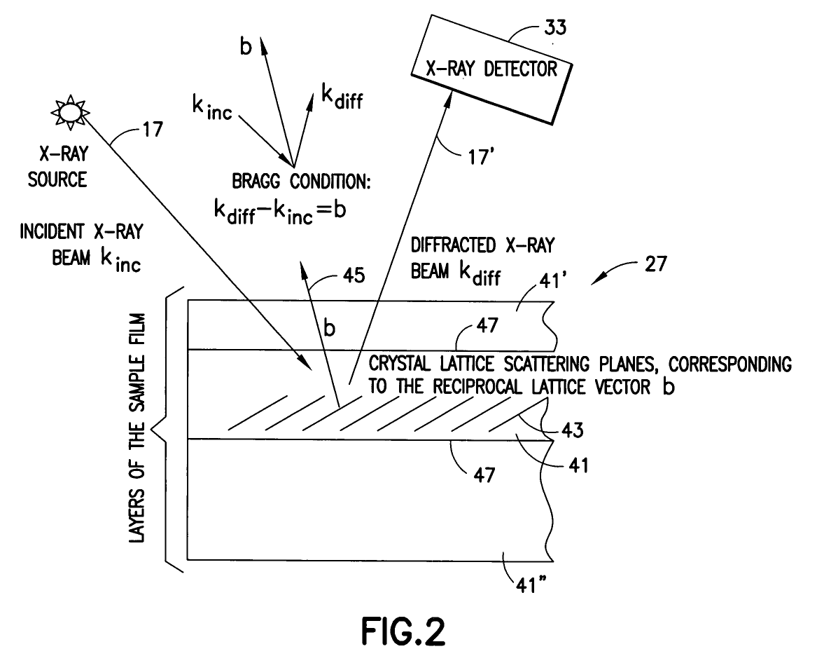

With reference to FIG. 2, there is illustrated in detail the interaction of the probe pulse 17, the sample 27, and the diffracted probe beam 17′. Sample 27 is seen to include exemplary film layers 41, 41′, 41″. In the example illustrated, probe pulse 17 is configured to measure the effect of pump beam 15 on film layer 41 as a function of time. Probe pulse 17 and diffracted probe pulse 17′ are configured to serve, respectively, as the incident x-ray beam k_{inc} and diffracted x-ray beam k_{diff} satisfying the Bragg condition (also referred to as Bragg's law): k_{diff}−k_{inc}=b, where b is the reciprocal lattice vector corresponding to the crystal lattice scattering planes 43 of film layer 41. K_{diff}, k_{inc} and b are all vector quantities. Wave vectors k_{inc} and k_{diff} are directed along the propagation of the corresponding probe pulses 17, 17′, and their lengths are equal to 2π/λ, where λ is the wavelength of the X-ray radiation. As noted above, the Bragg diffraction condition is described by the following equation:
b=k_{diff}−k_{inc} (1),

where b is the reciprocal lattice vector. When the Bragg diffraction condition is satisfied for the diffracted and incident X-ray beams k_{diff} and k_{inc} the intensity of diffracted probe pulse 17′ is at a maximum.

This maximum is sharp and its position is sensitive to the perturbations of the distances between the atoms, due to the elastic, or other lattice perturbations excited by the pump pulse 15. Probe pulse 17 is located sufficiently close to corresponding wave vector k_{inc} such that a detector 33 located along wave vector k_{diff} records a maximum, or near maximum, intensity in accordance with satisfaction of the Bragg diffraction condition. Preferably, the angle of incidence of the probe pulse 17 (to the lattice scattering planes) differs from that of k_{inc} by no more than about plus or minus two degrees, where k_{inc} is for maximum b.

In addition, deviations from expected results regarding the intensity of the detected diffracted probe pulse 17′ can yield information regarding the composition of the film under examination. For example, careful placement of the probe pulse 17 and the detector 33 is observed in accordance with satisfaction of the Bragg diffraction condition for the film layer 41 under examination. If, after precise placement of the probe pulse 17 and the detector 33, the expected maximum intensity is not observed, such an abnormal result can be correlated to an unexpected difference in the composition of the film layer 41. Specifically, such an abnormal result may be correlated to known differences in the crystal lattice scattering planes 41 arising from the introduction of different materials into the film layer 41 under examination.

As noted, the probe pulse 17 and detector 33 are positioned in accordance with the direction of the crystal lattice scattering planes 43 of the film layer 41 under examination. It is possible to employ the apparatus and methodology of the present invention in instances where a sample is formed, in part, of film layers 41 having essentially identical compositions, and hence, similar crystal lattice scattering planes. In such an instance, the signal formed in response to the emission of each pump beam pulse 15 will contain time delayed deviations in the intensity of the diffracted probe beam 17′ corresponding to the propagation of the acoustic signal through each similar layer 41.

While sound generated by the pump beam pulse 15, travels through the layer material, the distances between the atoms are changing, and the X-ray diffraction intensity at a given angle will change with time as the perturbation propagates through the film layers 41, 41′, 41″.

As noted previously with respect to FIG. 1, variable delay stage 25 introduces a variable delay between the times when the pump and probe pulses 15, 17 reach the sample 27 surface. The intensity of the X-ray radiation diffracted at a given angle between the pump and probe pulses 15, 17 is measured by the detector 33 at different values of the delay time.

This signal 49, containing the relationship between measured x-ray intensity and the time delay between the pulses 15, 17, thus contains the information about the sound propagation within a given layer.

Specifically, signal 49 expresses the variability of the X-ray intensity diffracted into a particular pre-fixed direction as a function of the time delay between the pump and probe pulses 15, 17. As the sound wave, formed from the interaction of the pump beam 17 with the sample 27, is propagated through multiple layers 41′, 41″ of the film sample 27 and is reflected at the interfaces 47, the sound wave carries information about additional film layers. Signal 49 can be utilized as the input to one or more data analysis algorithms for determining the film sample 27 parameters.

This signal 49 may be analyzed by means of modeling the propagation of light, sound, and scattering of the X-rays in the material, in order to extract the film parameters of interest. These parameters may include layer thicknesses and possibly one or more various mechanical, structural, and composition characteristics of the layers comprising the film. The parameters of interest may also include inter-layer interfaces, such as, but not limited to: elastic modulus, density, phase composition, and dielectric constants.

Preferably, signal 49 forms the input to an electronic computing device 51, including, but not limited to a personal computer capable performing the one or more data analysis algorithms upon the signal 49. Such an algorithm may be encoded in software readable by the computing device 51 or may be alternatively implemented in hardware.

High sensitivity of the technique is based on the fact that the diffracted probe pulse 17′ is sensed in the vicinity of the characteristic diffraction maximum for a layer of the film. Sound, or other excitation of the film material, will cause the shift in the diffraction peak position, shape, or intensity, leading to the X-ray signal being modulated by the propagation of the excitation through this layer.

The data analysis algorithm employed may predict the strain profile generated by the pump beam pulse 15, model its propagation through the film sample 27, and model the changes in the diffracted X-ray intensity induced by it for a given set of the film parameters values. Using non-linear fitting techniques described below, film parameter values can be optimized to minimize the difference between the measured and modeled signals. When such a difference has been minimized, the model is assumed to reflect the physical reality of the sample 27. Film layer 41 attributes, such as thickness, can be obtained from the model.

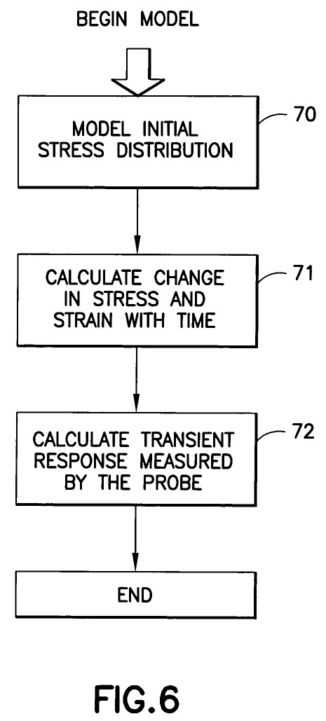

The above noted modeling proceeds in three basic steps (steps A-C below) as described with reference to FIG. 6.

(A) Initial Stress Distribution

The stress distribution in the sample 27 produced as a result of the absorption of the pump beam pulse 15 is calculated at block 70 using known values for the optical absorption of the various materials present in the sample, the specific heats of these materials, the thermal expansion coefficients, and the elastic constants. The effect of thermal diffusion may be taken into account to calculate the stress distribution. For a sample composed of several planar films of different materials with material properties uniform throughout each film the following procedure is used.

From the optical constants and thicknesses of the films the electric field due to the pump light pulse at all points in the structure is calculated in terms of the amplitude, angle of incidence, and polarization of the pump beam incident on the sample surface. This calculation is most readily performed through the use of optical transfer matrices. Next, from the calculated electric field distribution, the energy absorbed in the structure as a function of position is calculated. Next, the effect of thermal diffusion on the absorbed energy distribution is considered. Next, the temperature rise of each part of the sample is calculated. This temperature rise is the energy deposited per unit volume divided by the specific heat per unit volume. The stress at all points in the sample is then calculated from the temperature rise by multiplying the temperature rise by the thermal expansion coefficient and the appropriate elastic modulus.

(B) Change in Stress and Strain with Time

The change in stress and strain in the sample is next calculated as a function of time and position using the laws of physical acoustics at block 71. This calculation is effectively performed by means of a “stepping algorithm”, which performs the following computations.

First, a time step tau is chosen. For each film or layer that comprises the structure of interest a bin size b_{size} equal to the time tau multiplied by the sound velocity in the film is then calculated. Each film is then divided into bins of this size or smaller. By example, smaller size bins can be employed at any film boundary. The time step tau is chosen so that each film preferably contains a large number of bins. The results of the foregoing give the stress set up by the pump pulse in each bin of the structure. Next, the stress in each bin is decomposed into two components, one initially propagating towards the free surface of the sample and one away from it. Within a given film these two components are stepped forward from bin to bin in the appropriate direction. For a bin adjacent to the boundary between two films the stress propagating towards the boundary is stepped partly into the first bin on the other side of the boundary and still propagating in the same direction and partly into the original bin but propagating in the reverse direction. The fraction of the stress that is stepped across the interface and the fraction which reverses direction are calculated from the laws of physical acoustics. At the top (free) surface of the structure the stress in the bin adjacent to the surface and propagating towards the surface remains in the same bin but has its direction reversed, i.e., it becomes a stress pulse propagating into the interior of the structure rather than towards the top surface. By applying this procedure to all bins for a sufficient number of time steps tau, the stress distribution can be calculated for as long a time as is required for comparison with the measured results. From the calculated stress the strain is calculated by division by the appropriate elastic coefficient.

Samples that are of interest in semiconductor wafer chip fabrication typically have a number of thin films deposited on top of a semiconductor substrate. Presently, the total thickness of these thin films is a few microns or less, whereas the substrate is typically approximately 200 microns thick. An important advantage of this “stepping method” is that it is not necessary to consider stress propagation throughout the entire substrate. Instead it is normally sufficient to consider just one bin of the substrate together with “boundary conditions” specified as follows.

At each time step tau, the stress within the single bin of the substrate and propagating towards the substrate can be considered to be completely transferred into the remainder of the substrate so that no part of this stress is reflected. The stress within the substrate bin and propagating towards the film structure is taken to be zero. This description of the treatment of the substrate holds if the amount of light that reaches the substrate, after passing through whatever films are deposited onto the substrate, is negligible. This condition holds for the majority of structures which are of current industrial interest.

When this condition is not satisfied, and light does reach the substrate, it is desirable to include in the simulation a thickness of the substrate sufficient to include the entire depth over which the pump or the probe light can significantly penetrate. This depth is typically some number, e.g. five, of absorption lengths of the pump light or probe x-rays. This region of the substrate is then divided into bins of thickness as specified above. The last bin of the substrate is then treated according to the following boundary conditions

First, at each time step the stress within the last bin of the substrate, and propagating towards the interior of the substrate, can be considered to be completely transferred into the remainder of the substrate so that no part of this stress is reflected. Second, the stress within the last bin of the substrate, and propagating towards the film structure, is taken to be zero.

For some samples the above division of the simulation into the consideration of the calculation of the temperature rise and the propagation of the stress may not be applicable. It is noted that, as soon as energy is deposited into any part of the sample, a stress is set up and mechanical waves are launched into adjacent regions. If the diffusion of energy is sufficiently large and continues for a sufficient period of time then the changing temperature and associated stress distribution in the sample will continue to generate new stress waves. However, the extension of the simulation to include this effect is straightforward.

In some samples, particularly metal films of high electrical conductivity, a more detailed treatment of the diffusion of energy is required. The energy in the pump light pulse is initially input to the conduction electrons, thereby raising their energy considerably above the Fermi level. These electrons have a very high diffusion coefficient and may spread a significant distance through the sample before losing their excess energy as heat to the lattice. Under these conditions the diffusion of the energy is not adequately described by Fourier's law for classical heat conduction. Instead it is preferred to use a more microscopic approach, taking into account the diffusion rate of the electrons and the rate at which they lose energy.

(C) Calculation of the Transient Response Measured by the Probe

From the calculated change in stress and strain within the sample at any depth in response to an acoustic wave as a function of time, there is modeled an expected transient response at block 72. Measured signal 49 is compared to the modeled expected transient response. Non-linear fitting techniques are utilized wherein modeled film parameter values are changed so as to minimize the difference between the modeled transient response and the measured signal 49.

The sample 27, probe pulse 17, and the detector 33, are positioned to provide the necessary focusing for both pump beam pulse 15 and probe pulse 17. In addition, placements of the sample 27, probe beam 17, and the detector 33 are chosen to provide the desired angles between the direction from the X-ray source to the sample surface, orientations of the crystal lattice scattering planes within the sample, and the direction from the sample to the detector. These directions are preferably near to those satisfying the Bragg diffraction condition for the chosen film layer 41 material.

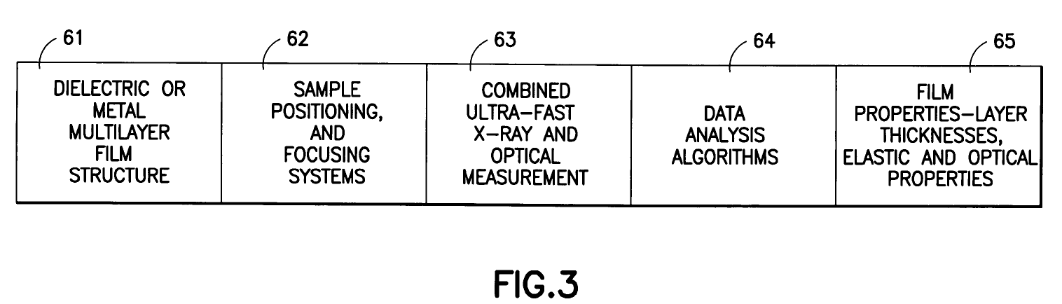

With reference to FIG. 3, there is illustrated a flow chart of the method of the present invention. At step 61, a dielectric or multilayer film structure is provided as a sample for measurement. At step 62, the sample is positioned in relationship to the pump beam pulse 15, detector 33, and probe pulse 17 as discussed above. At step 63, x-ray and optical measurements are performed as described above. At step 64-65, data is acquired by the detector and sent to the computing device where it is analyzed and the desired properties of the film are determined from the analysis.

The advantages of the apparatus and methodology described herein over existing XRR, XRD, and optical probe pulse systems are many. The spot size 31 defined by the size of the area of impact between pump beam pulse 15 and the surface of the sample 27 can be made smaller than the corresponding spot size of an XRR system. As noted above, the relatively large spot size arising in XRR systems is the result of the shallow incident angles used in XRR systems. The spot size of the present invention can be configured to be equal to or less than 5 um in diameter.

In addition, the present invention does not require a high resolution, high precision, angular scan as do XRR and XRD techniques. XRR and XRD deduce the thickness of film layers from a measurement of the X-ray diffraction peak shape. In contrast, the present invention measures the modulation of the intensity at a predetermined scattering angle satisfying the Bragg diffraction condition and extracts the film's thickness from the time dependence of the x-ray intensity.

The use of X-rays as a probe pulse 17 provides selectivity when measuring a layer. This selectivity makes data interpretation and modeling simpler as compared to optical probe beam systems wherein the measured signal is a convolution of responses from different levels. In addition, for measurements of films residing within periodic structures with sub-micron pitches, such as lines, the X-ray probe pulse beam is not subject to diffraction effects.

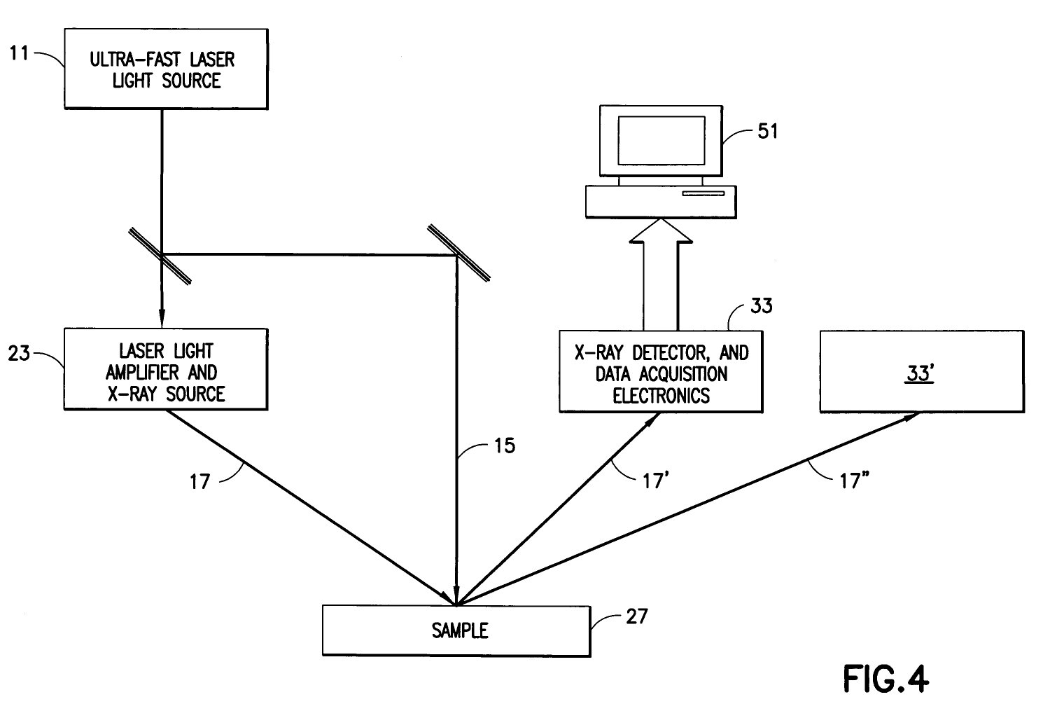

With reference to FIG. 4, there is illustrated an alternative embodiment of the present invention. In addition to detector 33, one or more additional detectors 33′ may be employed at the same time to measure a signal formed by the same or a different layer of the sample 27. As shown, there is employed a single probe pulse 17 with more than one diffracted probe pulses 17′, 17″ being detected by more than one detector 33, 33′. There may likewise be employed more than one probe pulse 17 arising from one or more light sources 11. The use of more than one probe pulse 17 coupled with the use of more than one detector 33, 33′ permits the near simultaneous detection of the generated acoustic pulse from different layers, or at different points within a layer.

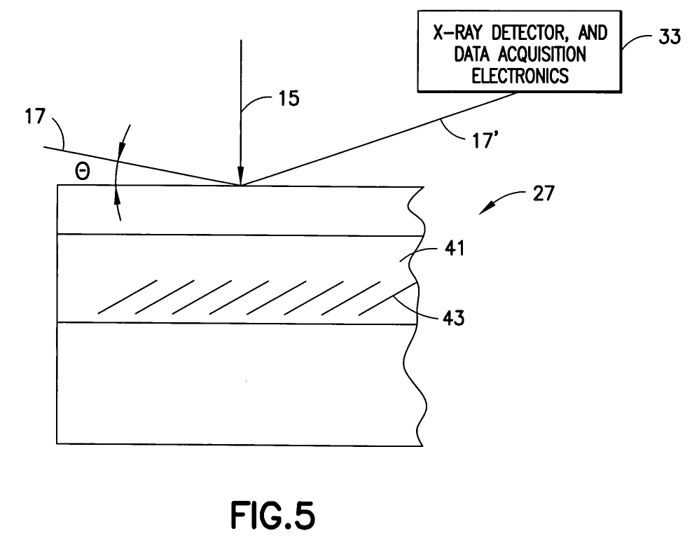

With reference to FIG. 5, there is illustrated an alternative embodiment of the present invention. Probe pulse 17 is directed at a surface of sample 27 at or very near to the grazing incidence angle theta. As used herein, “grazing incidence angle” refers to the angle at or below which all, or nearly all, of the incoming probe pulse 17 is reflected off of the surface of sample 27. When probe pulse 17 is placed at or near the grazing incidence angle theta, small perturbations in the surface of sample 27, such as those formed in response to pump pulse 15, cause the angle at which probe pulse 17 impacts the sample 27 to change. As a result, the angle at which the probe pulse 17 impacts the surface of the sample 27 oscillates around the grazing incidence angle theta. When probe pulse 17 impacts at an angle greater than the grazing incidence angle theta, part of the probe beam 17 passes into the sample 27 and the recorded intensity of the diffracted probe pulse 17′, now actually reflected, is diminished. Such a change in intensity may be used to form a signal as described above.

In an alternative embodiment of the present invention, a non-monochromatic probe pulse 17 allows for the simultaneous positioning of more than one detector to receive and detect the wide-band “bremstrahlung”.

In an alternative embodiment of the present invention, the system of the present invention can be combined with an x-ray diffraction (XRD) or x-ray refraction (XRR) system so as to collect additional data regarding the composition and material concentrations of the layers 41. Similarly, a hybrid system may be formed utilizing both an optical and an x-ray probe pulse 17 directed at the surface and detected by a detector or detectors 33. Preferably, both the optical and x-ray probe pulse 17 would be formed from the same laser light pulse.

1. A system comprising:
means for generating an optical pump beam pulse and for directing said optical pump beam pulse to a first area of a surface of a sample having a plurality of film layers to generate an acoustic signal;
means for generating an x-ray probe pulse and for directing said x-ray probe pulse to a second area of said surface;
means for detecting an intensity of a diffracted x-ray probe pulse said intensity varying in response to said acoustic signal to form a probe pulse response signal; and
means for calculating an expected transient response to a theoretical acoustic signal propagated through a model of said sample and fitting said probe pulse response to said transient response to derive at least one characteristic of said sample.

2. The system of claim 1 wherein said means for generating said optical pump beam pulse comprises a laser.

3. The system of claim 1 wherein said means for generating said x-ray probe pulse comprises a probe pulse modifying device.

4. The system of claim 1 wherein said optical pump beam pulse and said x-ray probe pulse are formed from a single light pulse.

5. The system of claim 4 wherein said single light pulse is comprised of laser light.

6. The system of claim 1 wherein said x-ray probe pulse is directed along an incident wave vector k_{inc} and diffracted along a diffracted wave vector k_{diff} such that b=k_{diff}−k_{inc}, where b is a reciprocal lattice vector of at least one of said plurality of layers.

7. The system of claim 6 wherein said means for detecting said diffracted x-ray probe pulse comprises a detector located along a direction of said diffracted wave vector.

8. The system of claim 1 additionally comprising a probe pulse modifying device for modifying a light pulse to form said x-ray probe pulse.

9. The system of claim 1 additionally comprising a beam modifying device for modifying said pump beam pulse.

10. The system of claim 1 wherein said associating means comprises an electronic computing device.

11. The system of claim 1 wherein wherein said x-ray probe pulse is substantially parallel to an incident wave vector k_{inc}, and said diffracted x-ray probe pulse is substantially parallel to a diffracted wave vector k_{diff} such that b is substantially maximized for b=k_{diff}−k_{inc}, where b is a reciprocal lattice vector of one of said plurality of film layers.

12. A method for measuring at least one characteristic of a film layer comprising the steps of:
generating an optical pump beam pulse and directing said optical pump beam pulse to a first area of a surface of a sample having a plurality of film layers to generate an acoustic signal;
generating a plurality of x-ray probe pulses and directing said plurality of x-ray probe pulses to a second area of said surface;
detecting an intensity of each of a plurality of diffracted x-ray probe pulses said intensities varying in response to said acoustic signal to form a probe pulse response signal; and
associating said probe pulse response signal with at least one characteristic of said sample.

13. The method of claim 12 wherein said generating said optical pump beam pulse comprises generating a laser light pulse.

14. The method of claim 12 wherein said generating said plurality of x-ray probe pulse comprises the steps of:
providing a probe pulse modifying device;
receiving a plurality of laser light pulses; and
modifying said plurality of laser light pulses to form said plurality of x-ray probe pulses.

15. The method of claim 12 wherein each of said plurality of x-ray probe pulses is generally parallel to an incident wave vector k_{inc} and each of said plurality of diffracted x-ray probe pulses is generally parallel to a diffracted wave vector k_{diff} such that b=k_{diff}−k_{inc} where b is a reciprocal lattice vector of said film layer.

16. The method of claim 15 wherein each of said plurality of x-ray probe pulses is within about plus or minus two degrees of said incident wave vector k_{inc.}

17. The method of claim 15 wherein each of said plurality of diffracted x-ray probe pulses is within about plus or minus two degrees of said diffracted wave vector k_{diff}.

18. The method of claim 15 wherein said detecting said plurality of diffracted x-ray probe pulses comprises providing a detector along said diffracted wave vector k_{diff}.

19. The method of claim 18 wherein said forming a probe pulse response signal comprises detecting a change in an intensity of said plurality of diffracted x-ray probe pulses as a function of time.

20. The method of claim 19 wherein said change in said intensity of said plurality of diffracted x-ray probe pulses as a function of time is a result of a propagation of an acoustic wave created from a contact between said optical pump pulse and said surface.

21. The method of claim 12 wherein associating said probe pulse response signal with at least one characteristic of said sample comprises the steps of:
forming a model of said sample utilizing at least one film parameter;
computing a transient response to an input pump pulse utilizing said model;
comparing said transient response to said probe pulse response signal;
employing a fitting technique to minimize a difference between said transient response and said probe pulse response signal; and
extracting said at least one characteristic of said sample from said model.

22. The method of claim 21 wherein said fitting technique is a non-linear fitting technique.

23. The method of claim 12 wherein said first area has a diameter to larger than 5 um.

24. The method of claim 12 comprising the additional step of employing an X-ray diffraction (XRD) system to analyze said sample.

25. The method of claim 12 comprising the additional step of employing an X-ray reflection (XRR) to analyze said sample.

26. The method of claim 12 comprising the additional step of employing an opto-acoustic metrology based system to analyze said.

27. A method for measuring a characteristic of a film layer comprising the steps of:
generating an optical pump beam pulse and directing said optical pump pulse to a first area of a surface of a sample having a plurality of film layers;
generating a plurality of x-ray probe pulses and directing said plurality of x-ray probe pulses to intersect a second area of said surface at an angle approximately equal to an incident grazing angle;
detecting a plurality of diffracted x-ray probe pulses to form a probe pulse response signal; and
associating said probe pulse response signal with at least one characteristic of said sample.

28. A signal bearing medium tangibly embodying a program of machine-readable instructions executable by a digital processing apparatus to perform operations to measure a thickness of a film layer, the operations comprising:
receiving an input comprising a time varying signal formed of an intensity of a diffracted x-ray pulse said intensity varying in response to an acoustic signal propagated through said sample;
modeling said sample using at least one model parameter;
calculating an expected transient response to a theoretical acoustic signal propagated through said modeled sample;
fitting said time varying signal to said transient response; and
measuring at least one of said at least one model parameters to obtain a characteristic of said sample.

29. The signal bearing medium of claim 28 wherein said fitting comprises utilizing non-linear fitting techniques.

30. The signal bearing medium of claim 28 wherein said fitting comprises reducing a difference between said transient response and said time varying signal.

31. An apparatus comprising:
a light source for generating an optical pump beam pulse directed to a surface of a sample having at least one film layer to generate an acoustic signal;
an x-ray source for generating an x-ray probe pulse directed to said surface;
an x-ray detector for detecting an intensity of the x-ray probe pulse after leaving the surface, said intensity varying in response to said acoustic signal to form a probe pulse response signal; and
a computing device for calculating an expected transient response to a theoretical acoustic signal propagated through a model of said sample and fitting said probe pulse response to said transient response to derive at least one characteristic of said sample.

32. The apparatus of claim 31 wherein said light source comprises a laser.

33. The apparatus of claim 31 wherein said x-ray probe pulse is formed from a light pulse generated by said light source.

34. The apparatus of claim 31 wherein said at least one film layer comprises a plurality of periodic structures.

35. The apparatus of claim 34 wherein said plurality of periodic structures comprise a plurality of lines.

36. The apparatus of claim 31 wherein said x-ray probe pulse intersects said surface at an angle greater than or equal to an incident grazing angle.

37. The apparatus of claim 31 wherein said x-ray probe pulse intersects said surface at an angle less than or equal to an incident grazing angle.
